(19) United States
(12) Patent Application Publication
(10) Pub. No.: US 2008/0097854 A1
(43) Pub. Date: Apr. 24, 2008

(54) Method for Creating and Analyzing Advertisements

(75) Inventor: Charles Young, Albuquerque, NM (US)

Correspondence Address: PEACOCK MYERS, P.C., 201 THIRD STREET, N.W., SUITE 1340, ALBUQUERQUE, NM, 87102, US

(73) Assignee: Hello-Hello, Inc., Albuquerque, NM (US)

(21) Appl. No.: 11/923,474

(22) Filed: Oct. 24, 2007

Related U.S. Application Data
(60) Provisional application No. 60/862,749, filed on Oct. 24, 2006.
(60) Provisional application No. 60/863,552, filed on Oct. 30, 2006.

(51) Int. Cl. G06Q 30/00; G06Q 90/00

(52) U.S. Cl. 705/14

(57) ABSTRACT

A method for analyzing advertisements and advertising campaigns. Important images are selected from one or more advertisements and then ranked. The most important images are then assigned to a category which preferably corresponds to a memory type, such as knowledge, emotion, or action. The relative numbers of images in each type determine the focus of the advertisement(s), and may be used to tailor the memory type(s) of subsequent advertisements.

### CROSS-REFERENCE TO RELATED APPLICATIONS

This application claims the benefit of the filings of U.S. Provisional Patent Application Ser. No. 60/862,749, entitled “Method for Creating and Analyzing Advertisements”, filed on Oct. 24, 2006, and U.S. Provisional Patent Application Ser. No. 60/863,552, entitled “Method for Creating and Analyzing Advertisements”, filed on Oct. 30, 2006, and the specifications thereof are incorporated herein by reference. This application is also related to U.S. Pat. No. 6,322,368, “Training and Testing Human Judgment of Advertising Materials”, U.S. Pat. No. 7,169,113, “Portrayal of Human Information Visualization”, and U.S. Pat. No. 7,151,540, “Audience Attention and Response Evaluation”, and the specifications and claims thereof are incorporated herein by reference.

### BACKGROUND OF THE INVENTION

1. Field of the Invention (Technical Field)

The present invention is a method for the analysis and creation of effective television commercials or other advertising, such as fast-ads, preferably utilizing Picture Sorts®, Flow of Attention®, Flow of Emotion® and/or Memory Sorts in order to create or identify Branding Moments.

2. Background Art

Note that the following discussion refers to a number of publications by authors and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Subjective time, as opposed to clock time, is fundamental to the film or video experience and by extension, television advertising. The elements of a commercial may be the pictures and the words that are laid out on a storyboard, but the audience experiences a commercial as movement, ideas and images that arrive in unfolding sequences and combinations that surprise, involve, and persuade.

Emotions in the audience are inextricably tied to a sense of the passage of time. For example, good movies “fly by” while bad movies “drag on.” In a dramatic scene a slowing down of time, or slow motion, might be used to heighten emotional tension.

Television commercials, and the newer forms of advertising such as online video, cell phone video or branded entertainment, are only line extensions of filmmaking. A major difference between entertainment and advertising is that advertising in all its forms must somehow move the consumer closer to a brand. Unlike entertainment, the goal of advertising film is not the immediate experience in itself but rather lies in the creation of lasting memories and emotional associations that build brand equity.

Which are best: simple advertisements or complex ones? Simple and direct are certainly one means to clarity of communication. Powerful emotions can be released in a single pure moment. But a drive toward increasing complexity is a fundamental force not only of the evolution of life but of technology and of culture and of the marketplace. As markets become increasingly segmented and refined, as brand positionings become increasingly nuanced, advertising evolves like language, with new definitions and categories of thoughts and images that create and organize brand memories.

Organization is a way of creating higher orders of the simple. Brands are important because they help us to simplify the complex process of decision-making in our busy lives. But how do advertisements create brands? Advertising does its work using attention getting and emotionally charged images to tag promised brand experiences which are filed away in the distinct, multiple memory systems of the mind.

### Moment by Moment Measurement Tools

Over the years a number of research techniques have been developed to get “inside” the 30-second time frame of a TV commercial for the purpose of providing diagnostic insight into the internal structures that distinguish effective from ineffective ads.

For example, physiological measures of various kinds—brain waves, facial response, and more recently new brain imaging techniques—have been used in an attempt to identify the biological basis of ad effectiveness. These approaches have particular appeal because of their promise of providing grounding in “hard” science being done on how the brain works for the “soft” science of advertising research. Because these approaches are linked to the rhythms of various physiological processes they also promise to provide insights into the role that various internal, biological clocks might play in synchronizing the processing of advertising. The downside of these approaches is that they are expensive, involve complicated, specialized equipment and highly trained scientific personnel, which makes them impractical for business practitioners to deploy for widespread use, particularly for day-to-day advertising research being done online.

Two other, more mainstream moment-by-moment diagnostic tools, widely used both online and offline, are dial meters and the Ameritest Picture Sorts®, the latter of which has been used to study consumer response to rough and finished TV ads, branded entertainment and web video.

The difference between dial meter results and picture sorts' results is quite interesting and is in part due to the different temporal frame of reference of each measure. The dial meter is measuring the commercial experience with regard to “clock time”, while the frame of reference for the picture sort measurements is the “subjective time” of the actual film experience. Picture Sorts deconstructs the visual channel of communication as a separate analysis from the audio (a companion technique, copy sorts deals with the verbal content of the ad), while dial meters track the combined audio/visual experience and contain an uncertainty range around which “moment” is actually being measured because of differences in respondent response times. For example, the physical reaction times of younger respondents used to playing video games are likely to be much faster than the reaction times of older respondents. This reaction time is more than just the time it takes for a signal to move from the brain to the hand, because there is also a time delay that occurs between perception itself and conscious thought.

Unless the dial meter tool is calibrated by normalizing the data to each individual's reaction time, the aggregate sample data will spread the response data over many measurement intervals. In contrast, the picture sort measurement is anchored in discrete still images, frozen moments of time, taken from the commercial itself. There is absolutely no uncertainty about which moment is being measured. As a result, dial meter data can be thought of as “analog” while picture sort data can be thought of as “digital” information.

Perhaps more significantly, respondents provide feedback at a much slower rate of signaling than the pace of information flowing through the commercial. The average thirty second commercial contains over thirteen cuts, representing thirteen distinct decisions by the director in the editing room regarding the cutting and timing of the film. It would be extremely rare to see a respondent casting thirteen distinct “votes” about the different shots in one thirty-second commercial. The result is that dial meters provide a more coarse-grained level of information, rather than the fine-grained level of information provided by picture sorts.

Dial meters record respondent reactions while they are watching the ad; but picture sorts are used by respondents to reconstruct the experience after the viewing. At first glance, this appears to be an argument for the traditional dial meter measurements as the ones being taken in “real time.” Many researchers have argued, however, that by making the respondent artificially self-conscious and critical during the viewing experience dial meters keep the respondent from “entering into the commercial experience.” By keeping the viewer “outside” the ad, the dial meter actually transforms the point-of-view of the measurement from an “advertising experience” into a “research experience.” Indeed, one of the dimensions of the experience that may be altered or distorted by the intrusion of dial meters is the respondent's sense of film time. It's the difference between performing a factory work task normally and performing the task when an efficiency expert is testing the worker with a stopwatch. Thus the two measurement tools produce different results because the frame of reference for measurement provided by dial meters is “clock time” while the frame of reference for the picture sorts measurements is the “subjective time” of the commercial experience.

### Sampling the Information Flow

Fast-cut editing of a commercial is a way of “speeding” through information. If an advertiser is trying to communicate a single, pure idea or feeling, with tunnel-vision and focus of attention it can speed toward it as fast as desired. That's a montage commercial. If an advertiser is trying to communicate multiple ideas or sales messages, then it must slow down, so that viewers can look around and take in the various ideas. The “speed limit” of a commercial is set by the complexity of the strategic concept advertisers are trying to communicate.

To measure the rate of information flowing through a commercial, advertisers could, as before, simply count the number of shots in the ad. However, camera shots can last a relatively long time, so that, as action unfolds, the visual information present in the beginning of the shot might be perceptibly different from that in the middle or at the end of the shot. For that reason, the number of pictures used in a picture sorting deck to represent its visual information content is usually greater than the number of shots or cuts. Moreover, the number varies from commercial to commercial, as a function of the sequential visual complexity of the ad. A typical sorting deck might contain from ten to forty pictures for a thirty-second commercial.

When the deck of pictures to be used in the sorting exercise is pulled, the human judgment of a trained researcher is used to decide whether or not one image that is adjacent to another in the sequence is sufficiently different to represent a new and a perceptibly meaningful difference in information for the viewer. The deck of pictures contains an esthetic vocabulary or repertoire, as discussed by Abraham Moles in his book “Information Theory and Esthetic Perception” (1968) which can then be used to probe the esthetic experience of the advertisement.

Viewed as a sampling process, the conceptual difference in how picture sorts draws its sample of the visual information flow of a commercial versus how a dial meter samples reactions to the ad content is illustrated in FIG. 1. A dial meter automatically records a measurement at a set time interval—for example, every two tenths of a second—the uniform measurement tick of clock time. In contrast, pulling frames for a picture sorts deck is a form of “stratified sampling,” where the stratification is based on a human judgment about the variable units of events, information and graphic objects as they appear in the ad.

FIG. 2 illustrates the different rates at which visual information might flow through a television ad; these are the information “timelines” produced by the picture sorts sampling process for three commercials. The number of frames describing each ad is plotted on the x-axis and the clock time from the beginning of the ad to when the picture was taken is plotted on the y-axis. Ad 1 shows an ad where information flows through at a slow rate (e.g. a stand-up presenter); Ad 2 shows a commercial at variable speed, where information went by more quickly or more slowly in different parts of the ad (e.g. where slow motion, stop action or other special effects might be used); and Ad 3 shows an ad with a fast rate of information flow (e.g. a montage).

Why would describing the performance of an ad based on the rate of information flow produce different results than a procedure based on clock time? Using a dial meter is like having an observer standing on the side of the road measuring the performance of a racecar with a stop watch. In contrast, the picture sort takes the point of view of the driver inside feeling the speed and acceleration of the machine. While both approaches may tell you something useful about the performance of the car, they are likely to produce very different descriptions of the driving experience.

Mathematically, there is an additional benefit for using picture sort. Still photographs are powerful ways to “freeze” emotions and memories in time. By sampling the commercial experience with stills, there is a “thin-slicing” or “partitioning” of the film experience into meaningful stimuli, each of which respondents can react to quickly with a variety of simple, non-verbal sorts. The data from these sorts may optionally be plotted as curves in order to reveal the hidden structure of ads in terms of how they are processed by the mind. The curves can vary wildly in shape, but some overall parameters of the commercial performance curves can be easily calculated. For example, to estimate the total “volume” of emotion flowing through an ad, the area under the positive and negative Flow of Emotion curves is calculated. This calculation does not require integral calculus-because of the partitioning already done, the simple average emotion across the deck of photos is used to compute the area.

### Speed and Performance

Prior research has shown that as the rate of information flowing through an ad increased, as measured by the number of shots in the ad, performance decreased—at least in terms of ad recall and persuasion. Slowing down the cutting speed of television commercials to reduce their visual complexity seemed to be a clear and unambiguous implication of their work. Despite these findings, advertisers continue to produce fast-cut commercials which, like the rest of the world, seem to be moving faster than ever. Counting shots is similar in concept to counting the number of pictures in a picture sort deck. Actually, because changes in visual content within a shot are also counted, picture sorts represent a fine-tuning of the previous approach for analyzing the effects of commercial speed. With this more sensitive tool, the prior analysis was replicated, but this time using the performance metrics of two major pre-testing systems, Millward Brown (which has a license to use Picture Sorts) and commonly owned system of Ameritest.

Each system measures attention and branding differently, however. Ameritest measures attention within a clutter reel format, where a test commercial has to win the fight for attention against four other ads, while Millward Brown derives its measure of attention from a composite of two rating statements about the commercial, on enjoyment and memorability. Ameritest measures how well a commercial is branded with a top-of-mind awareness of the brand name after the clutter reel exposure, whereas Millward Brown uses a five point rating of the commercial's fit with the brand. Despite these differences in how the two systems operationalize the theoretical constructs of attention and branding, the research demonstrates that the two systems generally produce similar outcomes with regard to the kinds of advertising executions their scoring systems appear to reward.

Consumer recall is thought to be a combined effect of attention and branding. Therefore, taken together, these two findings do not contradict the earlier research but rather provide some insight into the reasons for the negative relationship between the number of shots and recall. As commercials move faster, or become more visually complex, additional care must be taken by advertisers to ensure that their ads are well-branded.

If category differences are controlled for, when 120 packaged goods commercials tested in the Ameritest system and compared to 120 commercials for similar product categories tested in the Millward Brown system, the correlations are now quite similar, as shown in FIG. 3. And now that major category and brand development differences are removed, the relationship between commercial speed and motivation or persuasion is observable. Column 1 in FIG. 3 describes the visual complexity—the speed of the ad—from the “objective” or outsider perspective of the researcher choosing the number of pictures to use in the sorting deck. Replicating the findings of the earlier research, there is a significant negative correlation between commercial speed and the motivation or persuasion scores of both testing systems.

Further down the first column are a set of rating statements that are commonly used to explain the report card performance metrics. The relationship between the picture counts in the sorting decks and these diagnostics provides an insight into why the above correlations occur. As seen in FIG. 3 there is a strong positive correlation between visual complexity, that's the number of “picture-bits” in the ad, and how involving, interesting, and unique commercials are rated; similarly, there is a negative correlation between visual complexity and ratings of boring and ordinary. This fits with the positive correlation seen with the attention scores. The human eye is delighted by unusual forms, colors and movement—kaleidoscopes engage attention.

On the other hand, there is a negative correlation between the visually complex and how important the message is perceived to be or how relatable the situation shown in the ad is—though suspiciously, there is no significant correlation with confusion ratings. But these diagnostics help explain the negative correlation with motivation or persuasion scores. Fast-talking salesmen are less likely to persuade.

In an age of increasing media clutter, breaking through all that noise, and getting a product's foot through the door of the mind is of paramount importance. The first, though not the only, job of advertising is to get noticed. And viewers reward with their attention ads that are visually complex, involving, interesting or unique and ignore ads that are too simple or too slow if they are boring and ordinary, which is why advertisers and their agencies persist in developing visually complex advertising.

The creative trick, of course, is to strike the right balance between getting attention and being well-branded and motivating.

As stated above, commercial “speed” was defined from an objective point of view of the information flowing through the ad—which is an “outsider” perspective. The data from the “insider” point of view, which is how the audience has processed that information, must also be considered.

### SUMMARY OF THE INVENTION

### Disclosure of the Invention

The present invention is a method for analyzing advertisements, the method comprising the steps of selecting a plurality of images from the advertisement; ranking the images; generating a subset of the images; and classifying each of the images in the subset into a plurality of categories. The ranking step preferably comprises determining the number of viewers who remember each of the images, or alternatively comprises determining the strength of emotional engagement produced in a plurality of viewers for each of the images. One or more of the categories preferably correspond to a memory system. The memory system is preferably selected from the group consisting of knowledge, emotion, action, and brand identity. The classifying step preferably comprises determining from a plurality of viewers which category the image is most closely associated with. The classifying step optionally comprises classifying an image in more than one category. The method preferably further comprises the step of determining the focus of subsequent advertisements in an advertising campaign based on the number of images in each category taken from previous advertisements in the campaign. The focus is preferably determined by which category contains the most images.

The present invention preferably comprises a method for identifying branding moments in advertising films (e.g. television commercials, online video, cell phone video, etc.) by correlating Flow of Attention and Flow of Emotion. In the creation of individual advertisements the method can be used in the editing or optimization process for video or film. In the management of a set of advertisements comprising an advertising campaign, the method can be used to analyze, track or keep an accounting of the different types of memories that are being created in the minds of target audiences.

The present invention also preferably comprises an automated method for categorizing different types of brand imagery in film (e.g. Knowledge, Emotion, Action, and Brand ID) using audience response. The method for categorizing memory types is preferably based on respondent self-report data in response to one or more of the following types of questions: a) verbal descriptors used to classify pictures (for example “This image made me think”; “This image made me feel an emotion, e.g. ‘security’, ‘confidence’ or ‘beautiful’ etc.; “This image made me experience a physical sensation e.g. ‘smell’, ‘taste’, ‘heat’, ‘motion’, etc.” b) graphic symbols such as a stylized head (knowledge), heart (emotion), hand (action) or set of facial emoticons etc.; or c) iconic, photographic imagery that can serve as standardized reference points to different kinds of perceptions and experiences that are filed away in different memory systems of the brain. Ratings obtained from respondent data are used to classify each Branding Moment image into one or more of the memory types.

The present invention further preferably comprises a method for sorting and displaying, on a computer screen or in hard copy reports, the different types of branding moments in advertising film.

The present invention also further preferably comprises a computer program for the interviewing sequence for interpreting the results of the Branding Moments™ quadrant as shown in FIG. 7 and categorizing them into the Brand Image Monitor chart columns of FIG. 8.

An object of the present invention is to provide a method for identifying and classifying the Branding Moments™ in an individual advertisement or the set of ads comprising an advertising campaign.

An advantage of the present invention is that advertising campaigns can be adjusted according to memory tag content.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with a description, serve to explain the principles of the invention. The drawings and the dimensions therein are only for the purpose of illustrating one or more particular embodiments of the invention and are not to be construed as limiting the invention. In the figures:

FIG. 1 is a sampling process chart displaying the difference between how picture sorts draws its sample of visual information flow versus how a dial meter samples reactions to an ad's content;

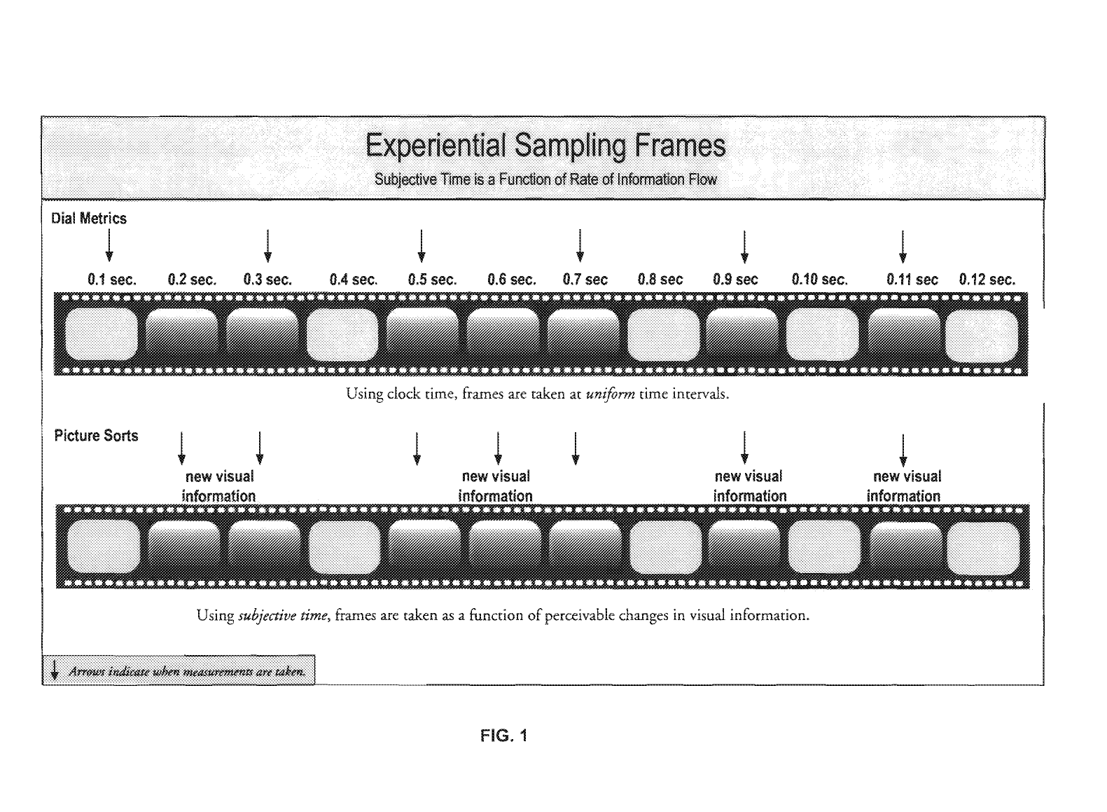

FIG. 2 is a graph illustrating different rates at which visual information flows through a television ad;

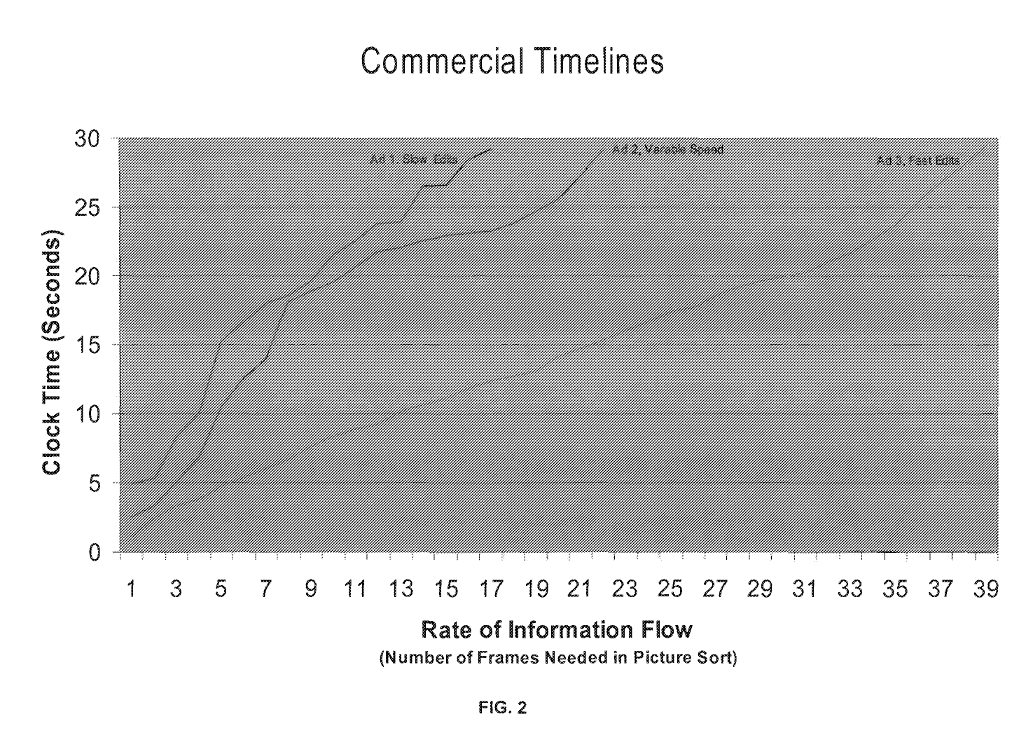

FIG. 3 is a correlation of Picture Sorts® parameters with performance metrics from two pre-testing systems;

FIG. 4 is a flow of attention graph;

FIG. 5 illustrates perception of commercial speed and commercial performance;

FIG. 6 is a chart illustrating perceptions of fast commercial time and Picture Sorts® flows;

FIG. 7 shows branding moments of an example commercial; and

FIG. 8 is a brand image monitor of the present invention.

### DESCRIPTION OF THE PREFERRED EMBODIMENTS

### Best Modes for Carrying Out the Invention

The present invention builds on previously patented ideas to provide new insights into the processes involved in how advertising leads to the creation of brands. The present invention assists in creating and tracking advertising campaigns that make long term image deposits in each of the multiple memory banks of the mind. It provides management with a valuable tool for accounting for the different balances of advertising imagery being deposited. The ideas and images of effective advertising enter the multiple memory systems of the mind of the consumer more quickly than ineffective advertising.

### Audience Processes: Memory, Emotion and Performance

The visual complexity of a piece of film can be defined in more than one way. Simply counting the number of picture-bits of visual information in the film misses the role of rhythm and timing, dramatic tension and resolution—all the structural elements of good storytelling that come into play in organizing the audience's experience of a commercial. All these things affect how audiences process advertising images in order to integrate them into brand concepts.

To see how this happens, the “insider” perspective (i.e. of the person sitting in the driver's seat) of the viewer of the ad is required. For this, picture sort data is analyzed after it's been processed by the audience.

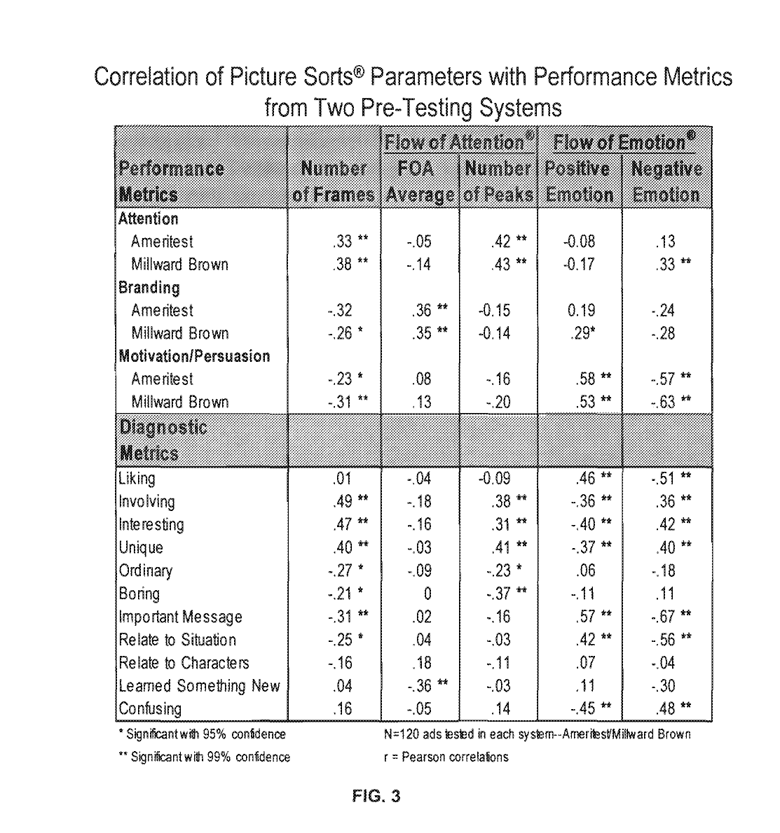

In the remaining columns in FIG. 3 the data produced by two picture sorts: the flow of attention and the flow of emotion is examined. First, two parameters that are used to describe the flow of attention curve are discussed: (1) the average level of recall, which describes the height of the curve (a norm-based concept); and (2) the number of peaks or focal points in the curve, which describes the shape of the curve in terms of the frequency with which certain images stand out more strongly against the background of the others (not a norm based concept.). After that, the flow of audience feelings through the film in terms of both positive emotions (or sensations) and negative emotions (or sensations) since together they can be used to describe the “dramatic tension” in the film is analyzed.

The simplest measure of processing is the percentage of images the audience actually remembers seeing in the ad—a binary sort of remember/don't remember. This measure of processing is captured in the flow of attention average shown in the second column of FIG. 3. The average level of recall in the flow of attention doesn't tell very much. While there is a modest correlation to branding, there are no significant correlations to any of the other advertising metrics. The correlation to branding suggests that better branded commercials are those where all of the information in the ad, including the brand identifiers, is well integrated into memory so that recall is higher overall. But simply remembering random images from a commercial at an above average level is not the real secret of well-branded advertising.

The images that stand-out above their neighbors are the focus of audience attention. They are in the foreground, front and center, of what the audience is looking at—or rather, searching for—in the film, while the other images around them are in the background of audience attention. These “peaks” and the measure of the frequency with which peaks occur in an attention curve are shown in column 3 of FIG. 3. The limited bandwidth of human information processing capacity is reflected in the time it takes for a viewer to organize the information from an ad. This is a significant factor shaping audience responses to speedy, visually complex commercials. From a visual storytelling perspective, the peak moments in a flow of attention curve can be thought of as the beat of the co-creative dance that takes place between the director and the audience—the director can lead audience attention by his rhythm and pacing of the visual information in the film, but the audience must follow.

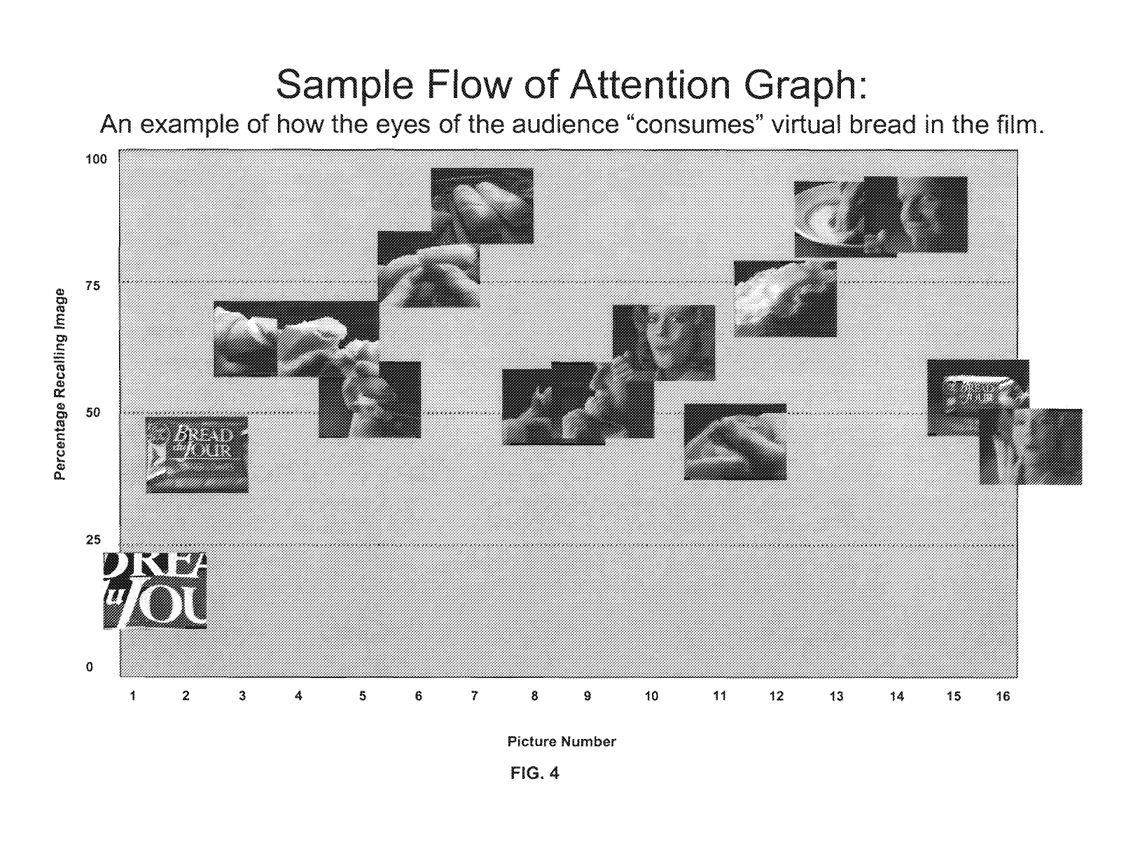

The flow of attention graph, as shown in FIG. 4, is a tool for visualizing the fundamental units of film structure. The fit with theoretical ideas and the empirical shape of an actual flow of attention curves is quite evident. Peak moments stand out in the arc of film processing. Operationally, a “Peak” should be understood as a relative term, not a statement about the absolute level of recall of an image—a peak is defined locally, as an image that is higher than the other images in its “neighborhood,” compared to the images before and after. The reason for this is that some curves start off slowly and build upwards as the viewer is drawn in, while others might start off quickly and then trail off as the audience loses interest.

Peak moments are those moments in the ad where assembly of the brand idea takes place, before the audience's “got-it!” blink. An average commercial contains between four and five peaks. But a particular commercial might contain one, as in the climactic moment of a reveal-type ad, or even none, as in montage. Column 3 in FIG. 3 shows the relationship between the number of peak moments of attention and advertising performance. As can be seen, more peaks are associated with more involving, interesting, and unique executions and hence higher attention scores in either pre-testing system.

The image content of the peak is most important, but even without content analysis of the four types of imagery that might occur in the peaks, by looking only at the abstract, the mathematical shape of the Flow of Attention curve has a significant correlation with attention, but not with motivation or persuasion. However, although attention is necessary it is not sufficient for advertising effectiveness. To understand one of the main drivers of motivation in advertising, a second picture sort, the flow of emotion, must be studied.

The flow of audience feelings through a television commercial can be thought of as the total volume of energy, both in terms of emotion that touch the heart or sensations that touch the body, pulsing through the ad. The job of an ad's creator is to shape and organize the audience's emotional experience in order to achieve certain dramatic effects in the service of the brand. A flow of emotion graph is a tool for visualizing the positive and negative energy in an advertisement or film. To analyze how well the ad has done its work, a content analysis of the commercial imagery should deal with how consumer emotions change from the beginning to the end of the ad, how dramatic tension is created between emotions (or sensations) with a positive versus a negative valence, and how those feelings are transferred to the brand. Previously, flow of emotion curves have been used to identify four different emotional archetypes, each of which can be the basis of effective commercial design.

To answer the frequently asked question about when to introduce the brand, the type of dramatic structure the ad's creators have chosen to work with must be identified. Depending on which of the four structures is used, the right time to introduce the brand is at the beginning, or in the middle, or at the end. The “early and often” rule for branding that is commonly cited by many of the older recall copy-testing systems applies to only one of the four dramatic structures.

Again, even without content analysis of the images in the ad, there are significant correlations between the mathematical description of the area under the flow of emotion curve—which are the average positive or negative ratings across the pictures being sorted—and motivation or persuasion. While emotions are strongly correlated with motivation, they are not, when viewed as isolated measures of positive and negative emotion, correlated with attention. This finding runs parallel with the overall independence of the measures of the attention-getting power and motivational impact of an ad—which is why such report card measures are viewed as complementary views of an ad's expected performance. This is the same reason why both the flow of attention and the flow of emotion are needed to explain an ad's performance.

In FIG. 3, under diagnostic metrics, there is shown a strong correlation with commercial likeability. But surprisingly, there's an inverse relationship between the valence of the emotion measure and the ratings of “involving,” “interesting” and “unique”—i.e. a negative correlation with positive emotions and a positive correlation with negative emotions. This undoubtedly reflects the legitimate role that negative emotions can have in many dramatic forms of advertising. In problem solution ads, the more negative the problem, the more important the solution. In dramatic storylines, the worse the villain, the better the story. An important point for content analysis of the imagery in the flow of emotion is making the distinction between intended and unintended negative emotions in an ad. Unintended negative emotions, either reflecting polarization of the commercial audience or simply mistakes in the execution, are inhibitors of motivation and introduce an additional variable into analysis.

Suspense and drama distort our perceptions of film time, reflecting the dramatic tension between positive and negative emotions. Compared to ads that are a simple recitation of positive brand benefits, ads that utilize negative emotions for dramatic effects engage the consumer in a greater mental effort in terms of working through to a resolution of dramatic tension. This explains why such ads would be seen as more involving, interesting and unique.

It is from the creative tension between positive and negative emotions that dramatic energy or conflict arises. “Conflict is to storytelling what sound is to music. Both story and music are temporal arts, and the single most difficult task of the temporal artist is to hook our interest, hold our uninterrupted concentration, the carry us through time without an awareness of the passage of time.”

Finally, there is a strong correlation between perceived message importance and positive emotional response. This could, of course, be interpreted as saying that the rational and the emotional can simply coexist—separate but equal—in the same ad; effective ads could simply mix, like colored sand, but not dissolve, like milk and tea, reasons and emotions. But the correlation can also be interpreted more strongly, reflecting the complex interactions between reason and emotion, which is the conclusion being reached by the latest brain researchers.

Through experience, re-confirmed by this new data, effective advertising leverages consumer emotions to magnify abstract ideas, making concepts seem even more important than they would be if they were simply tested in a traditional semantic concept test. The key to motivation is to express a relevant semantic idea in a dramatic way that leverages the esthetics of the advertising film.

### An Experiment with the Flow of Subjective Time

Time always seems shorter when doing anything at all than when doing nothing. One of the reasons people watch television is simply to pass the time. When television programming content is more interesting or engaging, time moves more quickly. So, a viewers' sense of time is affected when watching commercials, with the duration of strong commercials seeming to be shorter than weak commercials.

To investigate the relationship between a viewer's internal sense of time and commercial performance an experiment was conducted with 28 television commercials tested among a nationally representative sample of 2171 consumers. These were new 30-second commercials, tested within two weeks of airing on national television, from 15 different fast food restaurants. The commercials ran through the standardized interview of an online testing system—with one new rating statement to get at the perceived duration of these ads: “The commercial went by fast.”

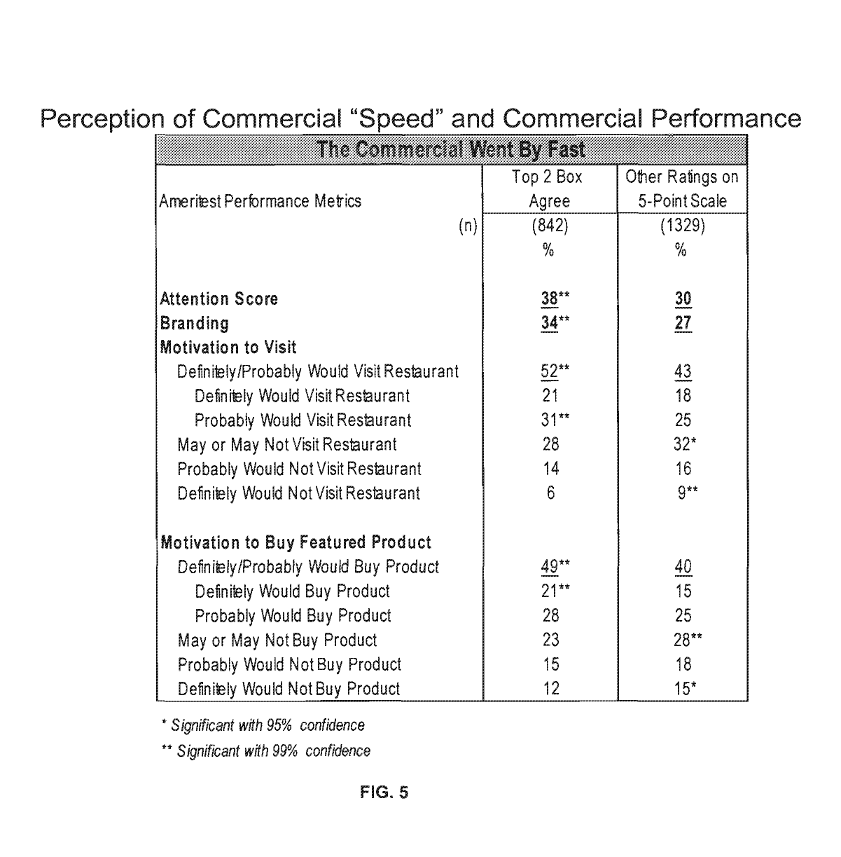

The relationship between ratings of “fast” and Ameritest commercial performance scores is shown in FIG. 5. The findings are significant. Commercials that are perceived to be “fast” are more attention-getting—38% versus 30%—a difference with 99% confidence given this sample size. Moreover, the commercials that are perceived to be “fast” are more motivating—52% versus 43%. Further, the branding score moves in the same direction, 34% versus 27%, suggesting that commercial speed is not a barrier to branding if the ad is well put together. Therefore, like a good movie, commercials that accelerate the audience's sense of time, seen from the viewpoint of the audience in the driver's seat, work faster in the brain.

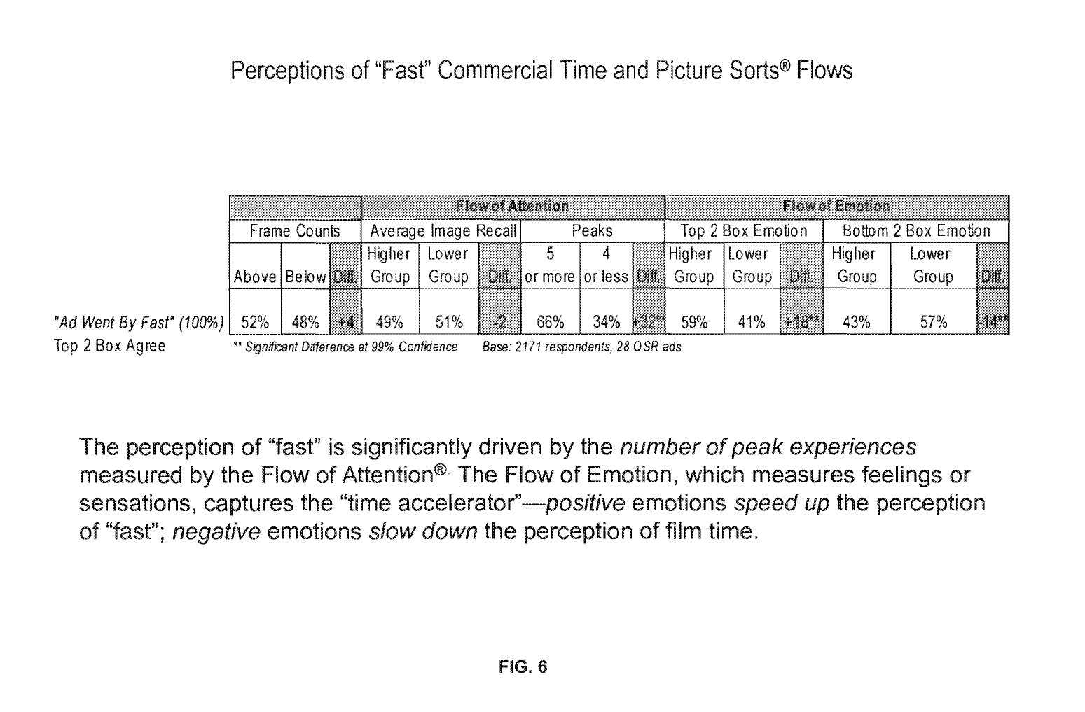

In FIG. 6, the picture sort variables are used to show the relationship between how the images from these commercials are being processed and the audience's perception of time. Interestingly, there is no relationship to the first picture sort variable, the “objective” measure of visual complexity, which is the number of pictures in the sorting deck. But the number of picture-bits of information in a commercial is not what's important. Movies are a sequence of connected images, each of which derives its meaning not just from its own unique content but also from its context and relationship to all the other images in the film. The average level of remembering does not correlate with the viewer's sense of time, either. This is because not every image in the commercial is equally important-though each image is presumably there for a good reason, some images matter more than others. The rest are the envelopes, not the message inside.

But the number of peak moments (focal points of attention) in the commercial does matter. Statistically, the relationship is striking—commercials with more than four peaks are twice as likely to be rated as “fast” than commercials with four or fewer peaks (the mean number of peaks was between four and five). The strongest association, and therefore the greatest determinant of the audience's perception of how fast an ad moves, appears to be the number of peaks in the flow of attention.

The positive flow of emotion also has a strong relationship to perceived time: positive emotions speed up the audience's perception of time. And, as anyone who has watched a good horror movie knows, negative emotions slowdown the audience's perception of time.

For communication to be effective, both the sender and the receiver must be mentally present for each other. But the present can run smoothly or it can be filled with turbulence. A set of three keys related to tags are needed to unlock all the doors of perception. Fast-working ads are ads where the brand becomes wholly present in the mind of the consumer—that is, the ideas and images enter all three memory systems of the brain to create the co-existent “present” of the ad. When all three keys are inserted, like the fail-safe keys used to launch nuclear missiles, the door swings open smoothly and the light of an idea fills the mind. It is here, in this timeless “micro-flow” state—a state which represents the creative response of the audience to the creative dance of the director—and which the present invention is sensitive enough to measure—where advertising does its work.

### Peak Moments of Attention and Emotion as “Tags” for Brand Memories

The flow of attention measures how the eye of the consumer views the film, acting as a pre-conscious filter or gate-keeper that sorts images into those of higher or lower importance to conscious attention. And the flow of emotion measures how the audience is feeling as they watch the film. The order in which things happen in the mind—which is perhaps the reverse order in which many researchers continue to think and talk about them—is important. The traditional sequence is to describe how advertising works in a logical and linear way: first, an ad has to break though media clutter and attract attention, perhaps with some entertaining or attention-getting hook; next, it has to communicate a sales proposition; which, if it is properly labeled, is somehow stored away in the consumer's memory files; so that, later, it can be retrieved when the consumer is confronted with an actual brand choice decision. Historically, this old mental model of how advertising works lead to the first widely used measure, recall-testing, as proof of lasting ad efficacy. But advertising is more than email to the mind.

Emotion comes first, memory comes second. Emotion arises in the immediate moment of an experience. Memory comes later, after the mind processes and consolidates the experience, real or imagined, that it has perceived. That's why advertising creatives put emotion first in the hierarchy of creative development. And that's the reason why researchers' historical emphasis on semantics or recall-testing drove them crazy. All theories of memory are simultaneously theories of forgetting. The flow of attention is a map of how quickly images from advertising film are being forgotten, within twenty minutes of viewing the ad. The patterns of our forgetting are not uniform, like light fading from the day, but are like the shriveling up of the fireworks of our experiences exploding in the mind. Measuring the flow of attention requires that a certain amount of time has elapsed before the measurement is taken. Not a very long time—normally the measurement is taken after about twenty minutes. But even after only a few minutes, and with a relatively small sample of respondents, say twenty or so, a robust, stable pattern of attention begins to develop.

In contrast, the measure of emotional response to advertising can be taken immediately, either with measures of physiological response, or it can be done later, with a picture sort, using the power of still photographs to freeze and preserve emotions that can be released again at a later point in time. The peaks of the flow of attention are like the spires of a gothic cathedral, left behind in memory after the scaffolding imagery has been taken down. This fits with the experience of re-watching movies that have been seen before. People look forward to the scenes that stood out the first time and remember with surprise the other scenes that were forgotten.

Between four and five peaks is the median number of images that stand out among the twenty-five images that might be used to describe a typical 30-second commercial. This number is interesting because it suggests that advertising film, like many other advertising phenomenon, appears to follow the famous Pareto principle or 80/20 rule—20% of the film does 80% of the “work” of a television commercial. Similarly, from their experience linking up thousands of commercial pre-test results with the ad memories found in market tracking studies, other researchers have reached a similar conclusion. They describe this distilled-essence of an ad as the “creative magnifier”. This is the reason why comic books work, and, for advertisers, the animatic testing of commercials in rough form. What the existence of peaks in the flow of attention demonstrates is that a person's memory stores visual images in a form like comic strips.

Because peak images are the long-lived parts of an ad, they can be used to retrieve the memory traces of commercials that have been off-air for a very long time. Memories of commercials that had been off-air for five years or more can be recalled successfully with cues using peak visuals, but not with the other images from a commercial. Moreover, peak images have been found to be those moments in an ad where the viewer reports that she is both thinking and feeling, while other moments where she is doing one without the other, thought without emotion or emotion without thought, do not become peaks. Together, emotion and thought create meaning, a picture tagged with a caption. This suggests that memories are formed by building bridges between the rational and the non-rational parts of the brain.

The grandfather of modern memory research, Endel Tulving, actually described three different memory systems in his book The Elements of Episodic Memory (1983): (1) the semantic memory system, where facts, concepts and language are stored; (2) the episodic memory system, where sensations, emotions and personalized memories are stored (e.g. where were you on the morning of Sep. 11, 2001?); and the procedural memory system, where learned behaviors and sensations of bodily movement, such as how to tie your shoelaces, drive a car, or play a violin, are stored. Recent research of Raymond and Page discusses how each of these memory systems might be important for storing and retrieving the different parts of a commercial, and therefore for branding: “One of the emerging facts from cognitive neuroscience is that our conscious experience, i.e., the contents of the global workspace, is highly organized; it is not a haphazard jumble of associations and sensory information. Information appears to be organized in such a way as to provide us with a coherent description of discrete objects and events. We call these ‘representations.’ Each representation pulls together the relevant bits of information about something in the world: an object, person, place, event, or concept (such as a brand). The little bits of information are called ‘tags’ and can come from external real objects or from memory and imagination . . . a representation of something, say, an ordinary object, a brand, or concept, must have at least three tags, one for each of the mega modules: knowledge, actions, feelings.” (Page, G. and Raymond, J., “Cognitive Neuroscience, Marketing and Research”, Presented at the ESOMAR Conference, Sep. 17-20, 2006.)

Tags are fundamental building blocks of complex dynamic systems of all kinds, from biology to the stock market. Tags are essential for creating order out of chaos. At a higher level of description, brands themselves are tags for the marketplace. To extract advertising memories from the jumbled gallimaufry of the brain it appears that brands must have three different names. There is a key distinction between semantic information and esthetic information. In technical terms, “semantic” information is the part of a message that can be translated from one channel of communication to another, e.g. from the eye to the ear—the part of a picture you can describe in words. The “esthetic” information is the part of message that is lost when you change channels—the part of the picture that you cannot put into words. For television commercials the primary channel for semantic information can only loosely be thought of as the copy (minus the word images or poetry) while the primary channel for esthetic information is the video.

The way different types of information enter the brain is different also, with the semantic information being processed in a linear, “logical” sequence while the esthetic information is acquired through a non-linear, right-brain “scanning and sorting” process. One of the reasons the picture sorts work so well in explaining advertising performance is that pictures from the ad provide an ideal visual “vocabulary”—symbols from the symbol system of the ad itself—for probing the scanning and sorting processes by which the brain acquires esthetic information from moving pictures.

But through the work of the imagination, all three flavors of information can be expressed as images to be sorted into all three memory systems. Words can create mental pictures, through poetic devices such as analogy and metaphor, to be stored by association in the semantic system. People have imaginary relationships with celebrity images that are stored in the episodic system. Golfers rehearse their swing with the image of a virtual swing, visualizing perfection, just before they release the stored memories from their procedural system as they swing the club in real life.

Below are some examples of how tags for each of the three different memory systems might come into play when using the present invention.

### Knowledge Tags

Knowledge tags are the card catalog to the library of the mind. They are the key words, the author or title that you use to search through Amazon.com to find the book you want. Word-tags are important, which is why good domain names can be so valuable on the internet. Marketers spend a fortune just to put their names on the sides of sports stadiums.

Knowledge tags are the first names of brands, because at the beginning of a brand's life-stage, when it is a new product, semantic information content is high. That's why new product commercials need to be “introductory” in tone, heavy with semantic baggage, because they have the job of introducing the baby brand to the consumer, teaching the consumer who the baby is and how it fits into their world

Knowledge tags are the most familiar form of tags studied by advertising researchers since they're the basis of recall testing. Because the semantic system deals with language, these tags can be identified by researchers through the study of verbatim responses to open-ended recall questions or closed-ended rating statements. At a deeper level, they can be studied with Semantic Nets.

### Emotion Tags

The creation of easy-to-use tags by YouTube for ordinary people to search through the creative landscape of a hundred million home made videos is one secret of their current success. Hallmark built a fortune by marketing tags for human relationships in the form of greeting cards. One of the longest on-going debates among ad researchers concerns the correct types of cues—or tags—to retrieve long term memories of advertising: recall versus recognition. Both methods are valid since ad memories reside in all the memory systems of the mind. But the historical emphasis on verbal recall is really just an artifact of last-generation technology—telephone WATS centers were the cheapest way to collect advertising tracking data. Now that all ad tracking is moving online, the shift to visual recognition cues is gaining momentum. Emotional memories are more likely to be retrieved with visual recognition cues.

### Action Tags

The greatest trick Google ever played on the public was teaching all our fingertips to learn their name. The images of flying in an IMAX theater can make a viewer feel motion sickness. Video games, one of the most important advertising forms of the future, will deliver their value to advertisers to the extent that the embedded brands, integrated into the action of the games, become the tags for reliving the excitement of the game experience. Action tags reference the physical body, real or imagined. The Google experience is a form of kinetic imprinting. For film-makers, the question is how you reach through the eye to activate the other senses such as smell, taste, heat, movement.

Product-in-use shots, bite-and-smile food shots, the images of cars accelerating around California coastal highways, accident scenes where your insurance man was there to hold your hand are all obvious examples of advertising imagery that imprint an image into the procedural memory system. When the camera “consumes” a McDonald's hamburger on screen, it's as if the viewer, taking the point of view of the camera, ate the burger. Similar, in other ads, the viewer drove the car, reached out and touched someone—and that's how it's recorded in the viewer's mind.

It is the interaction of memory and projective imagination that creates the experiences of inner life. Indeed, it seems likely that one of the chief functions of advertising is to create “false memories” of brand experiences that never really happened in real life. When these imaginary experiences are mixed together in the mind with real experiences of the brand, the mind stores the false with the real in the same memory systems. Importantly, when these memories are later played back, the mind does not distinguish the false from the real. Food advertising can constitute a form of “virtual consumption”—which is why advertisers have long been taught to sell the sizzle, not the steak. Virtual consumption events multiply the number of experiences a viewer shares with a brand beyond the real ones. That's one of the reasons large advertisers enjoy such a strong business advantage over non-advertisers in terms of their ability to use advertising to strengthen brand relationships. Viewers can have more memories that this product which the viewers have never actually eaten tasted really good. FIG. 4 is an example of how the viewer “consumes” virtual bread.

It is important not to interpret the role of action tags literally, however. Not every food commercial needs to show a bite-and-smile shot. The role of metaphor can be important here—Target store advertising is not just about style, all that cool color and dance are also metaphors for the store experience so that the viewer remembers that it was fun shopping at Target. It's the visual warping special effects that make the viewer feel the sensation of the tight curve of the road so that the viewer remembers what a fast car that was. It's the warm fuzzy hug from the Snuggle bear that makes the viewer remember that this product is soft enough for a baby's skin. Action imagery doesn't have to be literal; it can be metaphorical. In general, while both emotion and action tags are about feelings generated in the audience, the difference is that emotion tags are centered on human relationships (including the relationship to the self) while action tags are centered on objects and physical behaviors.

Thus, the old dualities of the mind-body problem of classic philosophers are updated to the rational versus emotional debates that take place every day in advertising agencies and leads to an incomplete analysis of the communication problem; interpretation of the creative image must deal with the trinity of mind-body-heart. In the language of ad researchers, the trinity was the classical hierarchy effects model: think, feel, do. Contemporary researchers debate the order of the first two constructs. Does feeling come before thinking, or thinking before feeling? What's been overlooked is the “do” leg of the triad, the consumer consumption behavior, which is usually interpreted as taking place after the ad experience. The doing can also take place inside the ad, with action images mentally rehearsing the consumer behaviors the advertising is trying to motivate.

Finally, while there are three memory systems of the mind involved in the processing of images of all kinds, a fourth kind of tag is needed to integrate the other three—the identity tag. Without a brand identity tag, advertising still might drive sales by growing the category, but it won't drive market share.

### Brand Identity Tags

Names are only one way of tagging a commercial so that a brand doesn't end up in the lost luggage of the mind. Visual icons, like the McDonald's golden arches can tag a commercial. Sounds, like the Intel bong, do too. Recognizable shapes, like the classic Coca Cola bottle can tag a moment of falsely remembered refreshment. Or colors—if the actors are drinking out of a blue can, and not a red one, do you know which brand it is? Or tag lines—“Just do it!”

Although four specific tags are described above, any number of tags may be identified and used.

### Using the Tags

The present invention preferably utilizes picture sorts to produce a simple tool for identifying and classifying the “branding moments” in a television commercial—which is a key reporting tool for managing advertising campaigns.

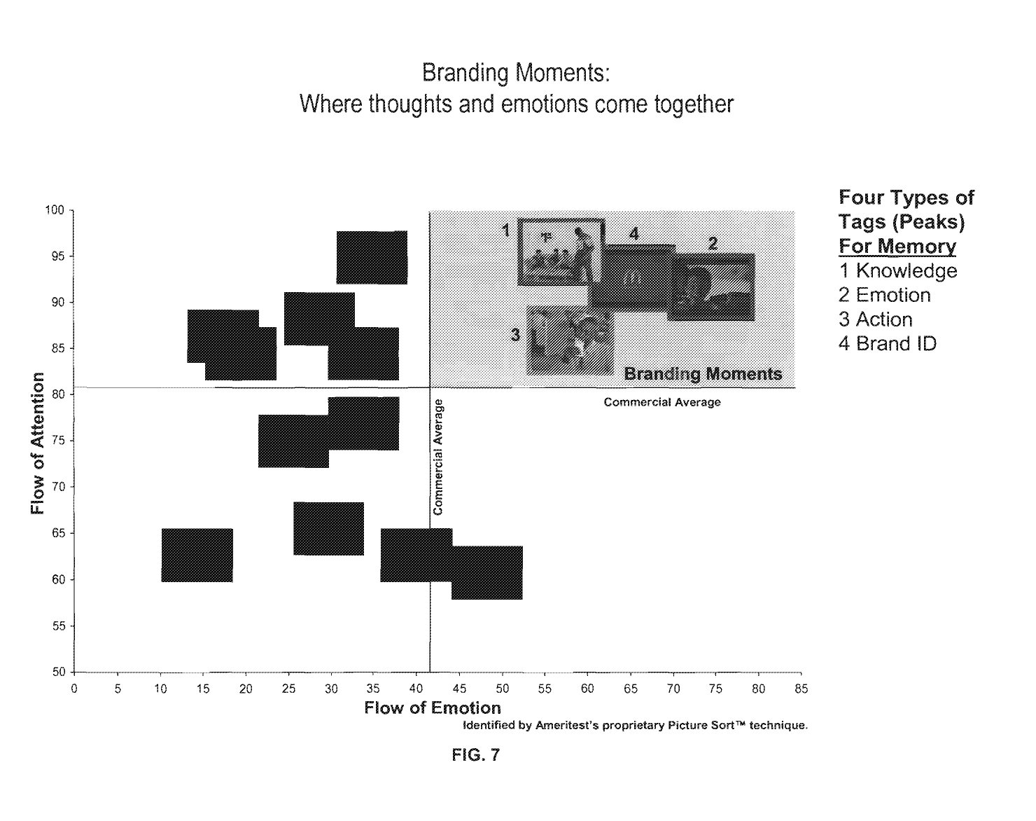

Since the flow of attention and the flow of emotion sorts provide different and complementary insights into how an audience interacts with film, both in terms of audience search and emotional imaging processes, an embodiment of the present invention plots the two time-series of visual information in a grid, like that shown in FIG. 7. This allows for a cross-reference of emotional experience versus attention and memory. Pictures plotted in the upper right hand corner of FIG. 7 represent the moments in the commercial or commercial campaign that are both high on audience attention (technically these should be peaks) and emotional engagement. These images are the branding moments of the ad—the strongest images from the ad that enter the memory of the consumer to form the long term image of the brand. In other words, these images are the memory tags.

Although picture sorts using flow of emotion and flow of attention is a preferred method of identifying the important images (branding moments) in an advertisement, any method may be used to analyze images and identify those which most strongly influence the viewer.

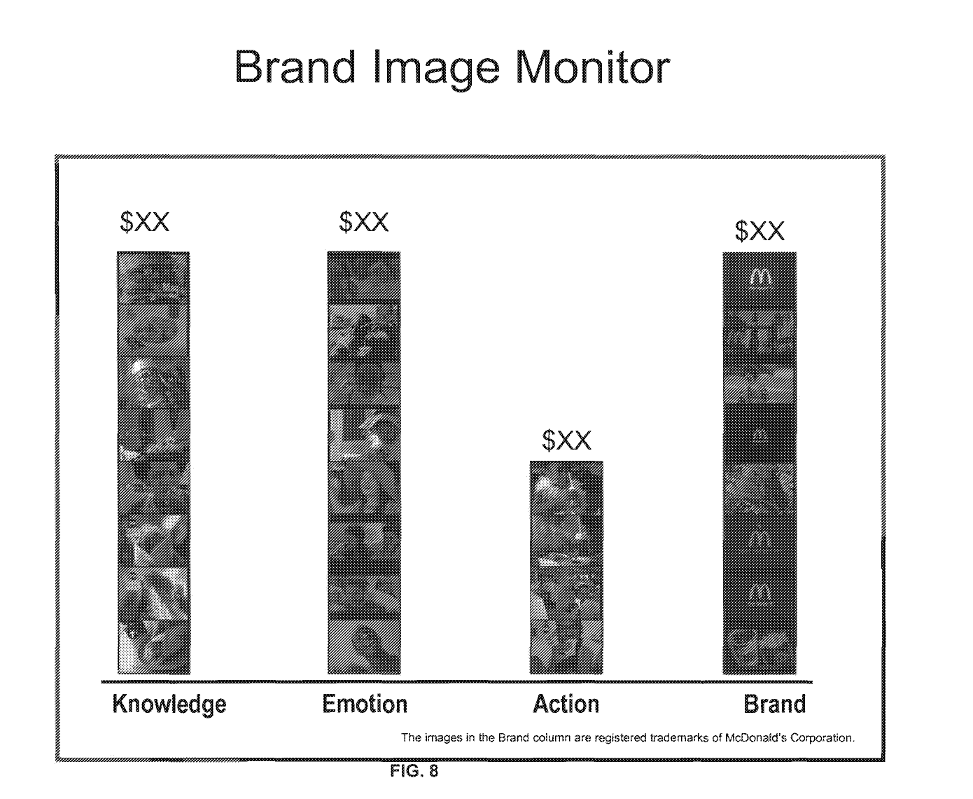

Content analysis of the branding moments can then be used to code for each of the three types of branding moments, or memory tags, corresponding to the three memory systems of the mind (knowledge/learning, emotion/feeling, and action/doing), plus the fourth type (the brand identity tag), as shown in FIG. 8. Thus each image can be allocated to the appropriate tag or memory type. This analysis is typically based on input from consumer response and optionally the judgment of trained ad experts, who may watch the advertisement and assess the particular image in the context of the entire ad.

The attachment of respondents' introspective thoughts about the types of memory being activated by each picture can be done with a third picture sort, the “Memory Sort”. This sort can be done in a variety of ways. For example, a respondent could be asked to choose from a short list of words or phrases to best describe the types of thoughts, emotions or feelings they got when they saw each particular image in the film. Alternatively respondents may sort images into categories based on symbolic cues. Icons may be used which requires no translation which makes global research easier. For example, knowledge may be denoted using a head icon, action may be denoted using a running man icon, and emotion may be denoted using a heart icon. A third alternative is to use a set of photographs which are known to stimulate different systems in the mind as a standardized frame of reference. These approaches may be used individually or in combination as an aid to respondent introspection.

The classification approach can be used to identify the dominant memory system activated by an image or it can be used to provide the respondent or the researcher the flexibility to characterize the image as residing in more than one category (for example ⅓ action and ⅔ emotion). For example, if 60% of the respondents identified a particular Branding Moment image as belonging to the action tag, and 40% of the respondents identified the image as belonging to the emotion tag, the image could, for example, be (a) assigned to the action category since the majority of respondents classified it as such; or (b) be assigned 60% to the action category and 40% to the emotion category.

### Automated Method

For the human mind, the fundamental triad of our past, present and future experience is sensation—emotion—thought. For the digital mind of the machine the triple helix is number—word—picture. An automated method for querying and analyzing viewer thoughts preferably comprises the following steps:
collect picture sort data with wireless palm pilots, cell phones, laptops, or the like;
automate the graphing of the data to identify peak branding moments and measure the positive and negative emotional energy in the film;
automate the Measurement and Memory Sorts to create the number-word-picture triads of digital “thoughts”; and
display visual information online, including a web-based video editing tool for automatically producing summary videos of key picture sort learnings (preferably automatically synched to the beat of music).

### Implications for Business

Picture-tags form a critical lynchpin in the process of integrating the research information that will flow together into the web-portal control screens of advertising managers of the future. If researchers operating continuous ad tracking systems do not pick the peaks according to the present invention to use as a recognition cue for evoking memories of an ad once it's been aired, the measurement of in-market ad awareness can be seriously under-estimated. This can cause an ad manager to misread the effectiveness of an advertising campaign and lead to an understatement of the modeled advertising ROI.

Systems for automating the process of “farming audience response” to all the television advertising running in their product category have recently been implemented. In the fast food category, for example, forty new television commercials debut each month, nationally, from the top 20 advertisers. All of them are tested and the data uploaded, including the picture sort data described above, to a website every month.

Audience response to visual information flowing through an advertising campaign can be used to generate a graphically intuitive heads-up display, as seen in FIG. 8, for keeping advertising imagery of each type shown in balance, optionally within an individual advertisement, or across an entire integrated campaign.

This graphical display gives brand mangers a tool for managing advertising campaigns. Each of the four tiers can be thought of as a memory bank into which brand images must be deposited by advertising. A given commercial might, for example, deposit one or two or even three images in the knowledge bank. Another might make deposits in the emotion bank. A third commercial might deposit images in the first two banks but make the heaviest contribution to the action bank. Each of the commercials, to be well-branded, must also make deposits in the brand ID bank. Importantly, this leads us to a new form of “triple-entry” bookkeeping for the three different memory systems of the consumer. Current neuroscience suggests that, over time at least, an ad campaign should try to keep the image deposits roughly in balance. To build a complete representation of a brand in the mind of the consumer, all three memory systems are preferably engaged. If deposits are only made in the knowledge bank, you are building a concept, not a brand. Similarly, if deposits are only made in the emotion bank, without regard to rehearsing consumption behaviors in the action bank, or without occasionally grounding the brand in product news for the knowledge bank, the brand image will be similarly incomplete and out of balance over time.

In this “triple-entry bookkeeping,” the number and types of branding moments contained in a wide range of advertising can be used to weight or score the dollars spent on each of the preferably fast working films which will be created for different markets of the world. Using the present invention, ad managers of the future will be able to create a balance sheet of the images each of the parts of the fully integrated advertising campaign is depositing in each of the three brand image banks in order to control the investment of advertising dollars. Thus some advertisements in the campaign may be designed to focus on, for example, emotion (that is, contain more branding moments in the emotion category), while other advertisements may focus on, for example, action. As discussed above, this allows advertisers to adjust the campaign depending on the desired strategic objectives. For example, an advertiser may desire a balanced campaign; that is, one that has the number of branding moments in each memory type roughly equal. If the first ads are heavy on, for example, emotion and action, the advertiser may wish to create ads with a heavier focus on knowledge. However, the campaign does not have to be balanced; the strategic objective may be for a campaign to be weighted toward, for example, emotion.

### Implications for Science

It is of interest to compare the introspective data generated by the picture sorts with new brain imaging work and other physiological data to compare these inner and outer views of what really happens in the mind when people watch film. This works because you can use the picture sort to identify the exact moment in film when a certain mental event—pre-conscious attention, positive or negative emotional response—took place in the mind of the respondent. It is also of interest to explore the subject of how human consciousness develops. The present invention would be helpful here because it is pre-verbal.

### Implications for Creative Arts

Both Robert McKee and Scott McCloud have constructed complete theories in their books about how writers and graphic artists do the work of storytelling within well-defined principles of how the human mind works. We now have new tools to test their theories empirically, though writers and artists themselves undoubtedly require no “proof” of what they say—they would know the truth of these theories intuitively.

### Implications for Education

This method may optionally be used as a teaching and/or training tool, which is preferably input with research data on television content or ad content and used in a classroom as a tool for teaching students better media literacy. The picture sort is a tool that teaches people to see. Its output can be played with like a video game. To play is the highest form of learning. Thus this automated method may define a research “machine” for controlling video advertising in all its forms over the internet or anywhere else worldwide.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all patents, papers, and publications cited herein are hereby incorporated by reference.

What is claimed is:

1. A method for analyzing advertisements, the method comprising the steps of:
selecting a plurality of images from the advertisement;
ranking the images;
generating a subset of the images; and
classifying each of the images in the subset into a plurality of categories.

2. The method of claim 1 wherein the ranking step comprises determining a number of viewers who remember each of the images.

3. The method of claim 1 wherein the ranking step comprises determining a strength of emotional engagement produced in a plurality of viewers for each of the images.

4. The method of claim 1 wherein one or more of the categories correspond to a memory system.

5. The method of claim 4 wherein the memory system is selected from the group consisting of knowledge, emotion, action, and brand identity.

6. The method of claim 1 wherein the classifying step comprises determining from a plurality of viewers which category the image is most closely associated with.

7. The method of claim 1 wherein the classifying step comprises classifying an image in more than one category.

8. The method of claim 1 further comprising the step of determining a focus of subsequent advertisements in an advertising campaign based on the number of images in each category taken from previous advertisements in the campaign.

9. The method of claim 8 wherein the focus is determined by which category contains the most images.
